(19) United States
(12) Patent Application Publication
(10) Pub. No.: US 2024/0134648 A1
(43) Pub. Date: Apr. 25, 2024

(54) IMPLEMENTING HETEROGENEOUS INSTRUCTION SETS IN HETEROGENEOUS COMPUTE ARCHITECTURES

(71) Applicants: Adrian C. Hoban, Cratloe (IE); Thijs Metsch, Bruehl (DE); Francesc Guim Bernat, Barcelona (ES); Niall McDonnell, Limerick (IE); Gershon Schatzberg, Redding, CA (US)

(72) Inventors: Adrian C. Hoban, Cratloe (IE); Thijs Metsch, Bruehl (DE); Francesc Guim Bernat, Barcelona (ES); Niall McDonnell, Limerick (IE); Gershon Schatzberg, Redding, CA (US)

(21) Appl. No.: 18/398,107

(22) Filed: Dec. 27, 2023

(51) Int. Cl. G06F 9/30; G06F 15/80

(52) U.S. Cl. CPC G06F 9/3017; G06F 15/8038

(57) ABSTRACT

In one embodiment, an apparatus includes a plurality of processing cores, where each processing core is capable of executing at least one of a subset of an instruction set architecture (ISA). The apparatus also includes hardware circuitry to determine, during runtime, whether a thread comprising instructions of a particular ISA subset can execute on a particular processing core, and based on the determination, indicate a capability of the thread to be executed on the particular processing core in subsequent executions.

### BACKGROUND

Heterogeneous compute architectures can include a number of processing cores with varying levels of capabilities. Accordingly, some cores may implement heterogeneous instruction set architectures (ISAs) or ISA subsets. For example, one core may be able to implement a base instructions of an ISA, while another core may be able to implement an extended set of instructions of the ISA to exploit certain additional processing capabilities. However, in current compute systems, the extended set of instructions might not actually be implemented as the compute system may choose to only implement the base set of instructions or a “lowest common denominator” set of instructions to avoid potential conflicts during runtime (e.g., to avoid scheduling a thread with instructions of the extended set on the core that can only implement the base set of instructions).

### BRIEF DESCRIPTION OF DRAWINGS

Various examples in accordance with the present disclosure will be described with reference to the drawings, in which:

FIGS. 1A-1B illustrate example ISA supersets that include ISA subsets in accordance with embodiments of the present disclosure.

FIG. 2 illustrates an example processor that is capable of implementing heterogeneous instruction sets in accordance with embodiments of the present disclosure.

FIG. 3 illustrates an example system implementing thread tracking in accordance with embodiments of the present disclosure.

FIG. 4 illustrates an example process of scheduling a thread for execution in a heterogeneous compute architecture in accordance with embodiments of the present disclosure

FIG. 5 illustrates and example process of detecting ISA subset compatibility in a heterogeneous compute architecture in accordance with embodiments of the present disclosure.

FIG. 6 illustrates an example system-on-chip (SoC) that is capable of implementing heterogeneous instruction set architectures in accordance with embodiments of the present disclosure.

FIG. 7 illustrates an example computing system.

FIG. 8 illustrates a block diagram of an example processor and/or System on a Chip (SoC) that may have one or more cores and an integrated memory controller.

### DETAILED DESCRIPTION

The present disclosure relates to techniques for implementing heterogeneous instruction sets in heterogeneous compute architectures. Heterogeneous compute architectures may refer to processors or system-on-chips (SoCs) that include a number of processors or processing cores with varying levels of capabilities or features. In some cases, the processors/cores may implement heterogeneous instruction sets (e.g., different ISAs or ISA subsets). For example, some embodiments may include one core (e.g., an “efficient core”) that can implement a base instructions of an ISA and another core (e.g., a “performance core”) that can implement an extended set of instructions of the ISA to exploit certain additional processing capabilities. The various cores can have different architectures; for example, the efficient core in the example above may be a physically smaller core that is designed to maximize performance per Watt of power consumed and include a microarchitecture that is capable of executing a single thread; while the performance core may be physically larger than the efficient core and be designed to maximize performance, possibly without regard to power efficiency, by being able to execute multiple threads at once (e.g., hyper-threading).

However, in current compute systems, only one set of instructions may actually be implemented/executed at runtime. For example, only a base set of instructions of the ISA (and not any extended set of instructions) might be enabled to avoid potential conflicts during runtime, e.g., to avoid scheduling a thread with instructions of the extended set on the core that can only execute the base set of instructions. This is because, with current heterogenous compute architectures, a product might not offer benefits of some advanced instruction set/subset features as these are disabled to comply with constraints (e.g., operating system and application code constraints) to keep the instruction set homogenized. Once cause of the issue is that a fundamental of x86-based programming states that software should determine if a feature exists before using it. Given that features don't disappear, there is thus a requirement to check that the feature exists only once, and this is typically done in initialization routines, and once a feature is confirmed as available, the initialization routine sets up optimal code paths.

A heterogenous instruction set presents a fundamental challenge to this as workloads may be moved after the initial feature check routine, meaning a feature may become unexpectedly unavailable (leading to instability) or an available ISA extension that is very efficient at a particular task may not be used resulting in higher energy consumption than necessary. The former is the primary reason for current systems implementing the “lowest common denominator” instruction set to be used as the heterogenous processor ISA.

Accordingly, aspects of the present disclosure describe techniques for implementing heterogenous instruction sets, while also avoiding issues that can be present with different instruction sets or architectures (e.g., instability or increased energy consumption as previously described). Certain embodiments, for example, provide for an ISA superset to be presented to software (e.g., an operating system (OS)) as the ISA for the entire processor. The superset includes two or more subsets of instructions, with each subset being attributed to a set of processing cores of the processor. The OS may implement a thread tracking mechanism to track the ISA subsets utilized by each thread and/or processing restrictions for each thread. For example, the OS may use a system task status data structure or other data structure indicating runtime attributes for software threads (e.g., task_struct in Linux) to track thread attributes. Threads may begin without having an ISA subset/processing core restriction indicated in the data structure, e.g., indicating that the thread can be executed on any processing core of the processor.

The processor may include hardware circuitry to detect when a thread including instructions of a particular ISA subset is set to be executed or attempted to be executed on a processing core that is not capable of executing that ISA subset, halt the thread execution (e.g., trap the process or issue an interrupt to flag an exception handling process), and indicate to the OS that the thread is not able to be executed on the particular processing core. For example, the circuitry may determine that a thread includes instructions of a particular ISA subset and know that certain processing cores (including the one the thread has been scheduled on) are not capable of executing such instructions. The circuitry can accordingly provide to the OS an indication as to the ISA subset utilized or the processing core restrictions. The OS can then flag or otherwise indicate a restriction in the system task status data structure for the thread (to indicate the execution limitation), yield the processor, and put the thread back into the OS scheduling routines for execution on another core of the processor. The data structure can track, for each thread based on feedback from hardware, which ISA subset(s) the threads utilize and/or whether the threads have processing core restrictions (e.g., whether they can/cannot be executed on particular cores of the processor).

The OS scheduling routines can check the thread marker in the system task status data structure to determine if the thread has certain core limitations and can schedule execution of the thread accordingly. If the thread marker has not been set within the system task status data structure, then the scheduling routines may assume that the thread can be executed on any processing core. Accordingly, the task structure may be updated over time, with the updates monotonically moving from less restrictive to more restrictive. In some embodiments, to prevent instability in the system, the thread marker can be limited to making changes with more restriction (e.g., cannot be changed to indicate less restrictive execution).

As used herein, the term “instruction set architecture” (ISA) may refer to a set of instructions defined for a particular computer architecture. The ISA may include one or more instruction formats, and a given instruction format may define various fields (e.g., number of bits, location of bits) to specify, among other things, the operation to be performed (e.g., opcode) and the operand(s) on which that operation is to be performed and/or other data field(s) (e.g., mask). ISAs may include CISC-based instructions for CISC processor architectures (e.g., x86 architectures), or RISC-based instructions for RISC processor architectures (e.g., ARM, MIPS, or RISC-V architectures). ISAs can include a base set of instructions and extensions to the base instruction set. Example ISA extensions include 64 bit extensions (e.g., x86_64), advanced vector extensions (AVX, including Intel® AVX, AVX2, AVX-512, and Intel® AVX10) for x86-based ISAs, advanced matrix extensions (AMX) for x86-based ISAs, single instruction multiple data (SIMD) extensions for x86-based ISAs (including Intel® Streaming SIMD extensions such as SSE, SSE2, SSE3, and SSE4), advanced performance extensions (APX) for x86-based ISAs (e.g., Intel® APX), advanced encryption standard (AES) extensions for x86-based ISAs or RISC-based ISAs (e.g., ARM, MIPS, or RISC-V), scalable vector extension (SVE) for ARM-based ISAs, scalable matrix extensions (SME) for ARM-based ISAs), “Thumb” extensions to ARM-based ISAs, and more.

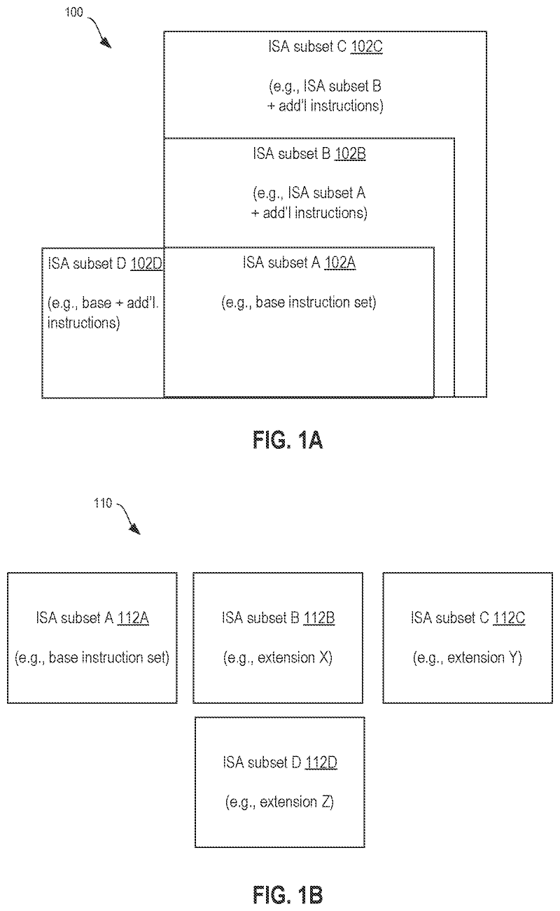

FIGS. 1A-1B illustrate example ISA supersets 100, 110 that include ISA subsets in accordance with embodiments of the present disclosure. In particular, FIG. 1A illustrates an example ISA superset 100 with “nested” instruction subsets 102A-D, and FIG. 1B illustrates an example ISA superset 110 with “buckets” of instruction subsets 112A-D. The ISA subsets shown in FIG. 1A are overlapping sets of instructions. As shown, the ISA subset 102A may include a base set of instructions for a particular ISA (e.g., the x86 base ISA), the ISA subset 102B includes the base set of instructions in subset 102A plus some additional instructions (e.g., instructions from an extension to the x86 base ISA), the ISA subset 102C includes the set of instructions in subset 102B (which includes the base set of instructions from 102A) plus some additional instructions (e.g., instructions from a further extension of the subset 102B), and the ISA subset 102D includes the base set of instructions in subset 102A plus some additional instructions (e.g., instructions from a different extension to the x86 base ISA than 102B).

In contrast, the ISA subsets shown in FIG. 1B are logically separate from one another. For instance, as shown, the ISA subset 112A may include a base set of instructions for a particular ISA (e.g., the x86 base ISA), the ISA subset 112B includes a first extension to the base ISA, the ISA subset 112C includes a second extension to the base ISA, and the ISA subset 112D includes a third extension to the base ISA. Though the subsets are shown in FIG. 1B as being separate from one another, they may include certain instructions from other subsets.

In either scenario, the ISA superset 100 or 110 may be presented to the OS as being the ISA for an entire processor, as described above. Each ISA subset can be attributed to a particular core or set of cores of the processor, and the CPUID (or similar) feature flag may be updated so that a default ISA exposed per core is the ISA superset or the ISA subset(s) supported by the core. Currently, a CPUID instruction provides a per-core list of all the attributes of each core. In certain embodiments, each core may be able to present to the OS certain ISA capability definitions per core. For instance, a default (first) ISA capability definition could become the superset ISA for the processor, and a second ISA capability definition could be the definition that accurately reflects that core. When the OS looks to discover what the processor cores are capable of executing, it may obtain the default superset listing. This can be discovered when running the detection routine on any of the cores in the processor, which can allow unmodified init routines to realize the capability exists in the processor to use any extensions. If the OS needs to know explicitly what a particular core supports, e.g., because it wants to pin precisely to that core and not allow the OS to move it, then it can get to that precise per-core capability information.

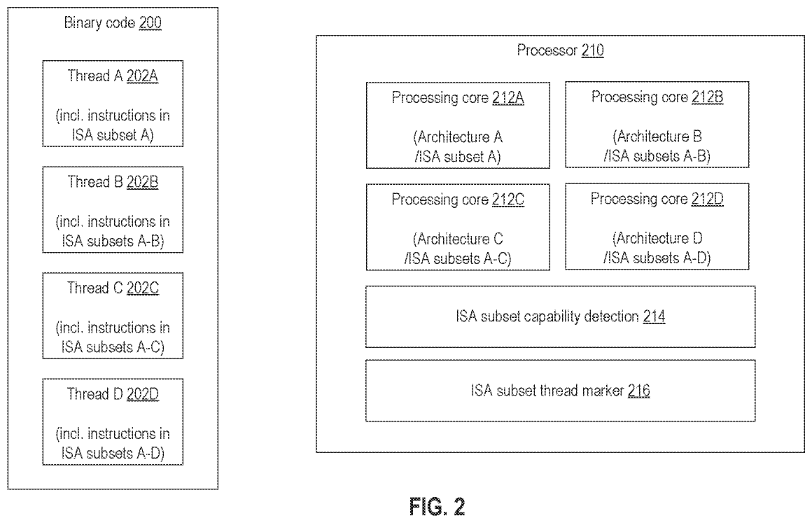

FIG. 2 illustrates an example processor 210 that is capable of implementing heterogeneous instruction sets in accordance with embodiments of the present disclosure. In the example shown, the processor 210 is to execute threads (e.g., 202A-D) of binary code 200. The binary code 200 includes a number of software threads 202, with each thread including a number of instructions according to an ISA. For example, each thread 202 may include instructions formatted according to an x86-based ISA format or according to another type of ISA format. In some embodiments, the processor 210 may be a virtualized processor, e.g., in an Intel© Scalable I/O Virtualization (IOV) computing environment or similar. In other embodiments, the processor 210 may include hardware accelerators that include front end circuitry to handle application processing interface (API) information from software, and aspects described below with respect to the cores 212 may be applicable to such accelerators.

In the example shown, the thread 202A includes instructions only from the ISA subset A (102A, 112A) in FIGS. 1A-1B, the thread 202B includes instructions from the ISA subsets A-B (102A-B, 112A-B) in FIGS. 1A-1B, the thread 202C includes instructions from the ISA subsets A-C (102A-C, 112A-C) in FIGS. 1A-1B, and the thread 202D includes instructions from the ISA subsets A-D (102A-D, 112A-D) in FIGS. 1A-1B. The processor 210 includes four processing cores 212, each with a different architecture that is capable of executing a different range of instructions from the ISA superset (e.g., 100, 110). For instance, the processing core 212A has a first architecture that is capable of only executing instructions from the ISA subset A (102A, 112A) of FIGS. 1A-1B, the processing core 212B has a second architecture that is capable of executing instructions from the ISA subsets A-B (102A-B, 112A-B) of FIGS. 1A-1B, the processing core 212C has a third architecture that is capable of executing instructions from the ISA subsets A-C (102A-C, 112A-C) of FIGS. 1A-1B, and the processing core 212D has a fourth architecture that is capable of executing instructions from each of the ISA subsets A-D (102A-D, 112A-D) of FIGS. 1A-1B.

The processor 210 further includes ISA subset capability detection circuitry 214 and ISA subset thread marking circuitry 216 for implementing execution of the heterogeneous instruction sets found in the threads 202 by the processing cores 212 of the processor 210. The ISA subset capability detection circuitry 214 can identify when an instruction of a thread 202 to be executed on a processing core 212 that is not capable of executing instructions within the thread. In particular, the circuitry 214 can detect whether instructions of a certain ISA subset within the thread 202 can or cannot be executed on a particular processing core 212, e.g., instructions in thread 202D cannot be executed by cores 212A-C because they include instructions from the ISA subset D. When this is detected by the circuitry 214, it can halt processing (e.g., trap the process or issue an interrupt), and the circuitry 214 can provide feedback to the operating system (OS) to update the system status task structure described above with an appropriate ISA subset marking. The thread then yields the processor/processing core, which causes the thread to be put back on the OS scheduler's queue for execution. Certain embodiments may implement the circuitry 214 within an Intel® Hardware Feedback Interface or as part of an Intel® Thread Director. The circuitry 214 may identify whether a thread can be executed on a particular core based on an ISA subset ID or related core/core range mask described above.

Although described above as being tracked in a software data structure (e.g., in on OS thread tracking data structure), in some embodiments, thread/core capabilities can be tracked in hardware instead. For example, the processor 210 may include ISA subset thread marking circuitry 216 that includes registers to store data indicating what ISA subset(s) threads utilize and/or whether the thread(s) have processing core restrictions (e.g., whether they can/cannot be executed on particular cores of the processor). In some embodiments, the thread tracking can be implemented using a combination of software (e.g., OS) and the circuitry 214.

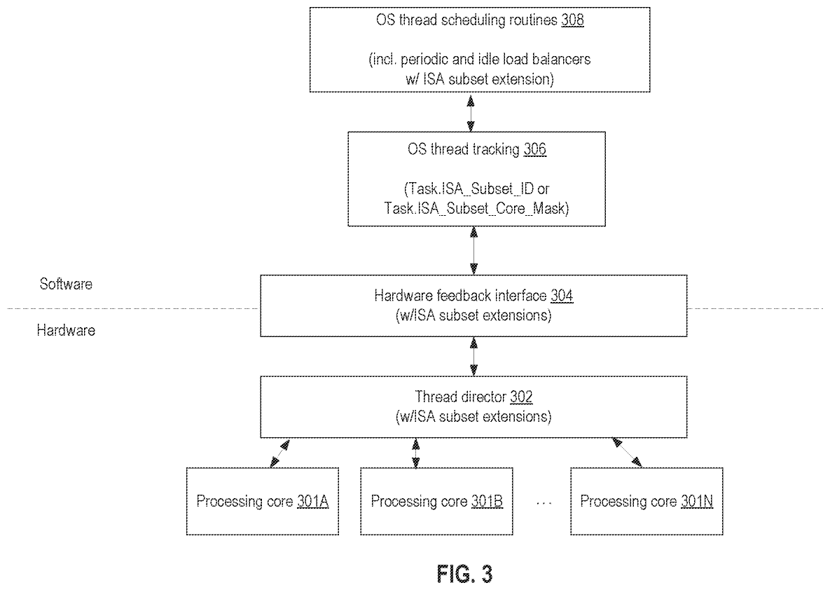

FIG. 3 illustrates an example system implementing thread tracking in accordance with embodiments of the present disclosure. In particular, FIG. 3 provides an overview of where ISA subset extensions may be included in a heterogeneous computing system, including both hardware and operating system portions. FIG. 3 includes certain references to Linux operating systems and Linux-based scheduling policies; however, the techniques described can be implemented in any operating system.

As shown in FIG. 3, the hardware side includes thread director circuitry 302 that schedules tasks/threads on the various processing cores 301 and provides to the operating system (via the hardware feedback interface 304) runtime feedback on the state of each executing thread and each core 301. In embodiments herein, the thread director circuitry 302 can also detect what ISA subset (e.g., 102A, 102B, 102C) is used by each thread and can provide the OS thread- or task-level restrictions, if detected, based on the ISA subset that the thread director detect is being executed by that task. The thread director circuitry 302 can also include the indicate to the OS whether a thread can/cannot be executed by a particular processing core 301, e.g., based on an attempt by the OS to schedule such thread on the particular processing core or based on the capabilities of each core 301 (which are known to the thread director circuitry 302). The OS can mark any restrictions reported by the thread director circuitry 302 in its thread tracking mechanism 306 (which can include the system task status data structure described above, e.g., task_struct in Linux). For example, the thread tracking mechanism 306 can write to the data structure an ISA subset ID for a thread that indicates which ISA subset the thread utilizes and/or can write to the data structure a core mask indicating which processing cores 301 the thread can execute on. In addition, negative results can be tracked as well. For example, the thread tracking mechanism 306 can write to the data structure an ISA subset ID for a thread that indicates which ISA subset does not have the capability to allow the thread to execute and/or can write to the data structure a core mask indicating which processing cores 301 the thread cannot execute on. The OS scheduling routines 308 can then look to the thread tracking data structure for any subsequent thread scheduling.

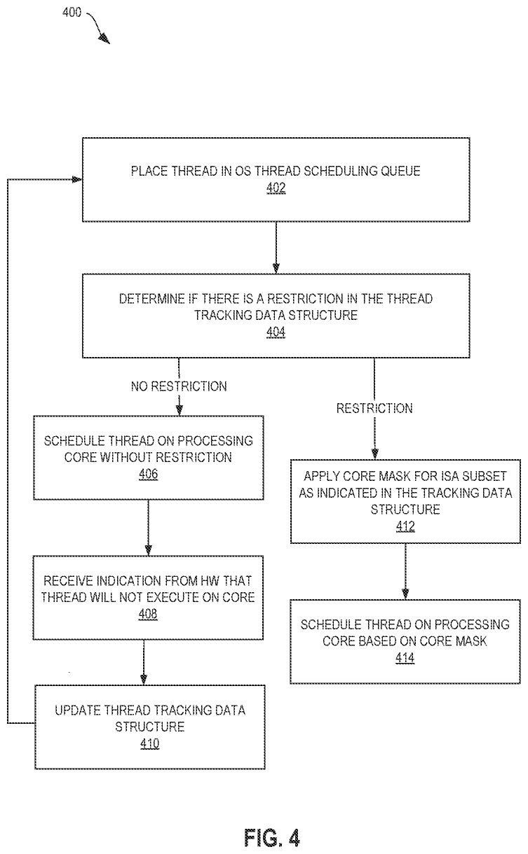

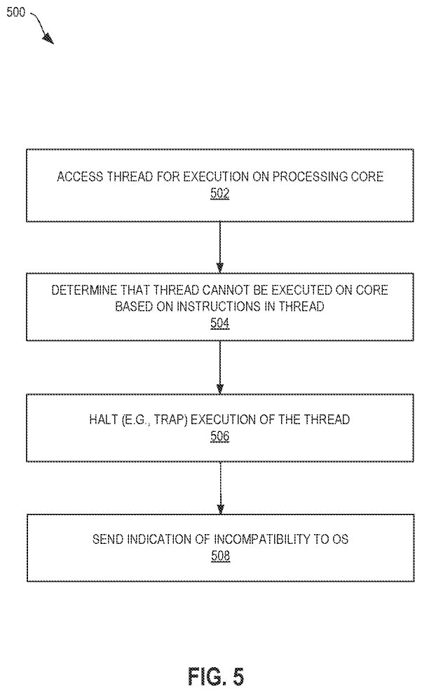

FIGS. 4-5 illustrate flow diagrams of example processes 400, 500 for implementing heterogeneous instruction sets in a heterogeneous compute architecture in accordance with embodiments of the present disclosure. The example processes shown may include additional or different operations, and the operations may be performed in the order shown or in another order. In some cases, one or more of the operations shown may be implemented as processes that include multiple operations, sub-processes, or other types of routines. In some cases, operations can be combined, performed in another order, performed in parallel, iterated, or otherwise repeated or performed another manner. In certain embodiments, the operations may be encoded as instructions (e.g., software instructions) that are executable by processor circuitry (e.g., circuitry in the processor 210) and stored on computer-readable media.

FIG. 4 illustrates an example process 400 of scheduling a thread for execution in a heterogeneous compute architecture in accordance with embodiments of the present disclosure. At 402, a thread (e.g., 202) is placed in the scheduling queue of an operating system (e.g., within the thread scheduling routines 308 described above). At 404, it is determined whether there is a core restriction (e.g., a core mask) indicated in a thread tracking data structure of the operating system (e.g., a data structure in the thread tracking mechanism 306 described above).

If there is no restriction indicated in the data structure, at 406, the thread is scheduled on a particular processing core or without any ISA related restrictions considered. At 408, an indication is received from hardware that the thread will not execute on the particular processing core selected by the operating system scheduling routines. This can include one or both of an indication of an ISA subset utilized by the thread and processing core restrictions for the thread. At 410, the thread tracking data structure is updated to indicate the information received. This can include indicating a core mask for a particular core or a range of cores in a positive or negative manner, e.g., whether the core(s) can or cannot execute the thread. The thread is then placed back on the operating system thread scheduling queue.

If a restriction is seen in the thread tracking data structure, then at 412, a core mask is applied for the thread to only allow scheduling of the thread on particular cores (e.g., 212 or 301) of the processor (e.g., 210). At 414, the thread is scheduled on a processing core of the processor based on the core mask applied. That is, the thread may be scheduled onto a processing core that is known to be capable of executing the ISA subset indicated by the thread tracking data structure.

Any other core selection decision making that the OS scheduler might perform can be performed either before, during, or after 414. For instance, in some embodiments, power efficiency information may be taken into account for scheduling tasks or threads on various cores of the processor at 414 (or 406). As an example, the OS scheduler may identify that multiple cores of the processor are capable of executing a thread, e.g., based on the core mask applied at 412 or otherwise, and may then further consider which of the capable cores can execute the thread in a more power efficient manner. This may be based on information obtained by the OS previously and/or on the OS recognizing that the thread does not include instructions of an ISA extension. For instance, referring to the example shown in FIG. 2, the OS may recognize that thread 202B can be executed on each of cores 212B-D, but may choose to schedule/execute the thread 202B on core 212B because execution on that core may be more power efficient than on cores 212C or 212D (e.g., due to their additional capabilities or based on other information known to the OS).

FIG. 5 illustrates an example process 500 of detecting ISA subset compatibility in a heterogeneous compute architecture in accordance with embodiments of the present disclosure. At 502, a thread is accessed by a processor for execution on a processing core (e.g., 212) of a processor (e.g., 210). At 504, it is determined (e.g., by a thread director such as 302) that the thread cannot be executed on the core based on the instructions utilized by the thread. For example, the thread may utilize instructions of an ISA subset that the processor core is not capable of executing as described above. Based on the determination, at 506, execution of the thread is halted (e.g., trapped) and at 508, an indication of the incompatibility is sent to the operating system, e.g., via a hardware feedback interface (e.g., 304). The indication may include an indication of the ISA subset(s) utilized by the thread and/or the core(s) of the processor that are or are not compatible (e.g., a core mask for the ISA subset). In this way, the operating system may be able to learn about the processor architecture, and determine which core(s) other threads utilizing the same ISA subset(s) may be executed on. In this way, the operating system may be able to apply core masks to other threads within the thread tracking mechanism.

The techniques described above can be applied to any suitable ISA type, including x86-based ISAs, ARM-based ISAs, RISC-V-based ISAs, or other types of ISAs. That is, the processor 210 may implement any suitable type of architecture for implementing a particular ISA and its subsets (e.g., a base set of instructions and extensions). Further, although the above describes examples of ISA subsets within an ISA superset (e.g., base and extension sets of a particular ISA, e.g., x86, ARM, MIPS, or RISC-V), the concepts can be extended to apply to architectures illustrated with respect to a another example, one processor chip of a SoC may implement a complex instruction set computing (CISC)-based architecture (e.g., an x86 architecture) while another processor chip of the SoC may implement a reduced instruction set computing (RISC)-based architecture (e.g., an ARM, MIPS, or RISC-V architecture).

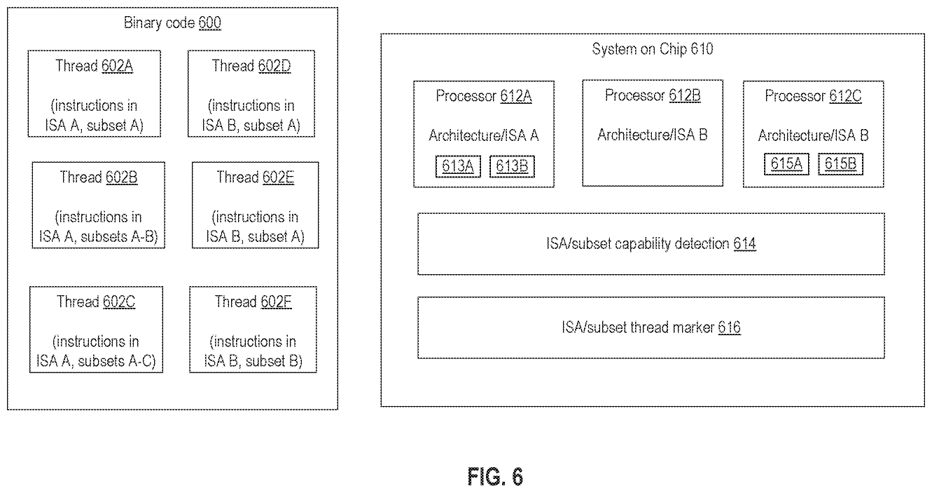

FIG. 6 illustrates an example system-on-chip (SoC) 610 that is capable of implementing heterogeneous instruction set architectures in accordance with embodiments of the present disclosure. The example SoC 610 is implemented similar to the example processor 210 described above, but includes processor chips/dies 612 that implement different ISAs. For instance, the processors 612A, 612B implement a first architecture with a first ISA and the processor 612C implements a second architecture with a second ISA. The ISA/ISA subset capability detection circuitry 614 may be implemented similar to the circuitry 214 described above, and may determine during runtime whether instructions in threads 602 of binary code 600 can be executed on a processor 612, and the ISA/ISA subset thread marker circuitry 616 may be implemented similar to the circuitry 616 described above to track and record ISA compatibilities of the various threads 602. For example, the circuitry 614 may be able to detect that the processors 612A, 612B can execute the threads 602A-C but not the threads 602D-F, and that the processor 612C can execute the threads 602D-F but not the threads 602A-C.

Further, the circuitries 614 and 616 of the SoC 610 can be implemented with the same techniques described above to further detect and control execution of threads utilizing different ISA subsets within each processor 612. For example, the processor 612A may include processing cores 613A, 613B of different capabilities, similar to the processing cores of processor, e.g., with each core 613A, 613B having the ability to execute instructions of a different subset within the implemented by the processor (ISA A). The circuitry 614 and 616 can thus further detect the ISA subset capabilities of the cores within the processors 612 as described above, and report to the software executing on those processors as to such capabilities.

For example, the core 613A may be able to execute only subset A within the first ISA A, and core 613B may be able to execute subsets A, B, and C of the ISA A as shown, and the circuitry 614 may be able to detect the capabilities of the respective cores 613 to execute the threads 602A-C in the same manner as described above. Similarly, the core 615A may be able to execute only subset A within the second ISA B, and core 615B may be able to execute subsets A and B of the ISA B as shown, and the circuitry 614 may be able to detect the capabilities of the respective cores 615 to execute the threads 602D-F in the same manner as described above.

Example Computer Architectures

Detailed below are descriptions of example computer architectures that may implement embodiments of the present disclosure described above. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

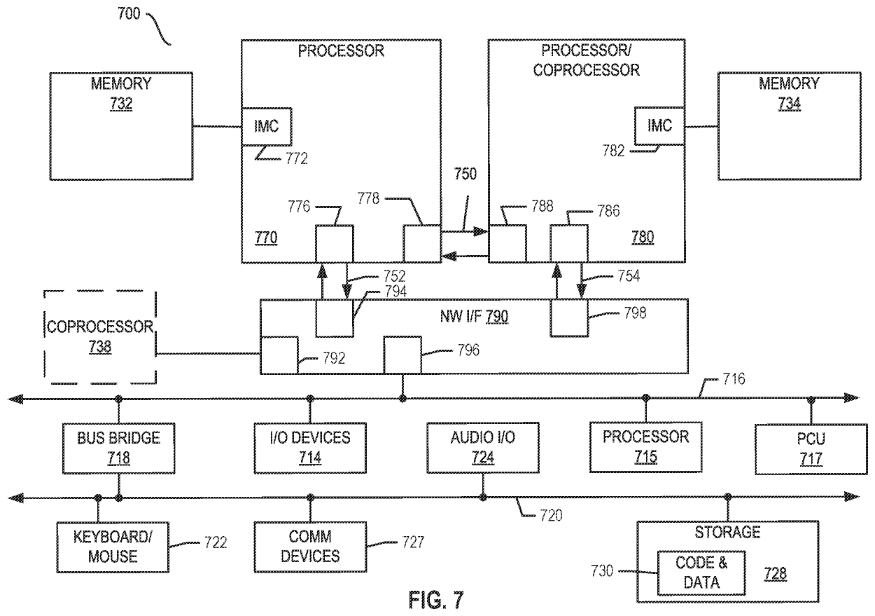

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as coprocessors, tensor processing unit (TPUs), neuromorphic compute unit, infrastructure processing unit (IPUs), data processing unit (DPUs), edge processing units (EPUs), GPUs, ASICs, XPUs, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

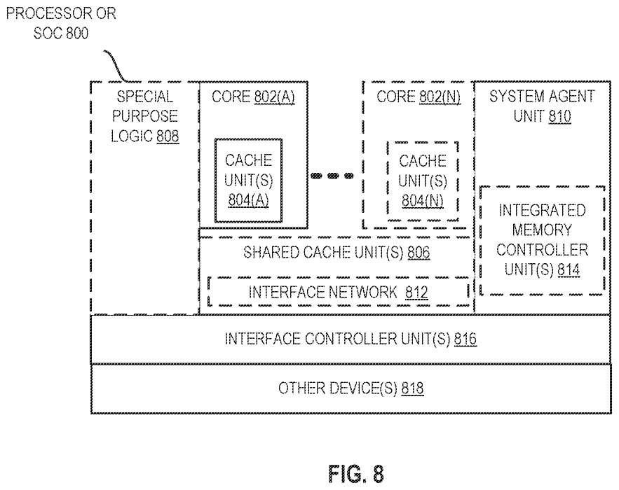

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA or ISA subset as described above; that is, a subset of the cores 802(A)-(N) may be capable of executing an ISA, while other cores may be capable of executing only a subset of that ISA or another ISA, or in another manner as described above.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (e.g. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### Further Example Embodiments

Illustrative examples of the technologies described throughout this disclosure are provided below. Embodiments herein may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 is an apparatus comprising: a plurality of processing cores, each processing core to execute at least one of a subset of an instruction set architecture (ISA); and hardware circuitry to: determine, during runtime, whether a thread comprising instructions of a particular ISA subset can execute on a particular processing core; and based on the determination, indicate to software a capability of the thread to be executed on the particular processing core in subsequent executions.

Example 2 includes the subject matter of Example 1, wherein the circuitry is further to: detect that the particular processing core cannot execute the instructions of the particular ISA subset; and based on the detection, halt execution of the thread on the particular processing core.

Example 3 includes the subject matter of Example 2, wherein the circuitry is to trap execution of the thread or issue an interrupt based on the detection.

Example 4 includes the subject matter of any one of Examples 1-3, wherein the circuitry is to determine that the thread cannot be executed on the particular processing core based on an attempted execution of the thread on the particular processing core.

Example 5 includes the subject matter of any one of Examples 1-4, wherein the circuitry is further to indicate a capability of the thread to be executed on other processing cores.

Example 6 includes the subject matter of any one of Examples 1-5, wherein the ISA is a complex instruction set computer (CISC)-based ISA.

Example 7 includes the subject matter of Example 6, wherein the ISA is an x86-based ISA.

Example 8 includes the subject matter of Example 7, wherein the thread is to execute instructions of one or more of an advanced vector extension (AVX) to the ISA, an advanced matrix extension (AMX) to the ISA, a single instruction multiple data (SIMD) extension to the ISA, an advanced performance extension (APX) to the ISA, and an advanced encryption standard (AES) extension to the ISA.

Example 9 includes the subject matter of any one of Examples 1-5, wherein the ISA is a reduced instruction set computer (RISC)-based ISA.

Example 10 includes the subject matter of Example 9, wherein the ISA is an ARM-based ISA and the thread is to execute instructions of one or more of a scalable vector extension (SVE) to the ISA, a scalable matrix extension (SME) to the ISA, and an advanced encryption standard (AES) extension to the ISA.

Example 11 includes the subject matter of Example 9, wherein the ISA is an RISC-V-based ISA.

Example 12 includes the subject matter of any one of Examples 1-11, wherein a first processing core is to execute a base set of instructions of the ISA and a second processing core is to execute an extension set of instructions of the ISA.

Example 13 includes the subject matter of Example 12, wherein the extension set of instructions of the ISA includes the base set of instructions of the ISA.

Example 14 includes the subject matter of any one of Examples 1-13, wherein a first processing core has a different architecture than a second processing core.

Example 15 includes at least one non-transitory machine-readable storage medium having instructions stored thereon, wherein the instructions, when executed on processing circuitry, cause the processing circuitry to: determine, based on information in a data structure indicating core execution restrictions for a plurality of threads, whether a thread has an execution restriction for one or more cores of the processing circuitry; schedule the particular thread for execution on a first core of the processing circuitry based on the determination; receive an indication from the processing circuitry that the thread cannot be executed on the first core; record an execution restriction for the thread in a thread tracking data structure based on the indication; and re-schedule the thread for execution on second processing core of the processing circuitry.

Example 16 includes the subject matter of Example 15, wherein the instructions are further to determine whether there is an execution restriction for the thread before re-scheduling the thread for execution on the second processing core.

Example 17 includes the subject matter of Example 15 or 16, wherein the instructions are to record an execution restriction for the first processing core based on the indication.

Example 18 includes the subject matter of Example 17, wherein the instructions are further to record an execution restriction for a plurality of other processing cores based on the indication.

Example 19 includes the subject matter of any one of Examples 15-18, wherein the instructions are further to determine which instruction caused the halted execution and record the execution restriction based on the determination.

Example 20 includes the subject matter of any one of Examples 15-19, wherein the instructions are further to determine a subset of an instruction set architecture (ISA) implemented by the particular thread and record execution restrictions for other threads in the data structure based on the determination.

Example 21 is a system comprising: first processor to execute a first instruction set architecture (ISA); second processor to execute a second ISA; and hardware circuitry to: determine, during runtime, whether a thread comprising instructions of a particular ISA can execute on a particular processor; and based on a determination, indicate a capability of the thread to be executed on the particular processor in subsequent executions.

Example 22 includes the subject matter of Example 21, wherein the first ISA is a complex instruction set computer (CISC)-based ISA and the second ISA is a reduced instruction set computer (RISC)-based ISA.

Example 23 includes the subject matter of Example 22, wherein the first ISA is an x86-based ISA and the second ISA is a ARM-based ISA or a RISC-V-based ISA.

Example 24 includes the subject matter of Example 22, wherein the first processor comprises a plurality of processing cores to execute at least one of a subset of the first ISA, and the circuitry is further to: determine, during runtime, whether a thread comprising instructions of a particular ISA subset can execute on a particular processing core of the first processor; and based on the determination, indicate a capability of the thread to be executed on the particular processing core in subsequent executions.

Example 25 includes the subject matter of Example 24, wherein the particular ISA subset is an ISA extension.

Example 26 includes the subject matter of Example 24, wherein the circuitry is further to: detect that the particular processing core cannot execute the instructions of the particular ISA subset; and based on the detection, halt execution of the thread on the particular processing core.

Example 27 includes the subject matter of Example 22 or 26, wherein the circuitry is to trap execution of the thread or issue an interrupt based on the detection.

Example 28 includes the subject matter of any one of Examples 24-27, wherein the circuitry is to determine that the thread cannot be executed on the particular processing core based on an attempted execution of the thread on the particular processing core.

Example 29 includes the subject matter of any one of Examples 24-28, wherein the circuitry is further to indicate a capability of the thread to be executed on other processing cores.

Example 30 includes the subject matter of any one of Examples 24-29, wherein the ISA is a complex instruction set computer (CISC)-based ISA.

Example 31 includes the subject matter of Example 30, wherein the ISA is an x86-based ISA.

Example 32 includes the subject matter of Example 31, wherein the thread is to execute instructions of one or more of an advanced vector extension (AVX) to the ISA, an advanced matrix extension (AMX) to the ISA, a single instruction multiple data (SIMD) extension to the ISA, an advanced performance extension (APX) to the ISA, and an advanced encryption standard (AES) extension to the ISA.

Example 33 includes the subject matter of any one of Examples 24-29, wherein the ISA is a reduced instruction set computer (RISC)-based ISA.

Example 34 includes the subject matter of Example 33, wherein the ISA is an ARM-based ISA and the thread is to execute instructions of one or more of a scalable vector extension (SVE) to the ISA, a scalable matrix extension (SME) to the ISA, and an advanced encryption standard (AES) extension to the ISA.

Example 35 includes the subject matter of Example 33, wherein the ISA is an RISC-V-based ISA.

Example 36 includes the subject matter of any one of Examples 24-35, wherein a first processing core is to execute a base set of instructions of the ISA and a second processing core is to execute an extension set of instructions of the ISA.

Example 37 includes the subject matter of Example 36, wherein the extension set of instructions of the ISA includes the base set of instructions of the ISA.

Example 38 includes the subject matter of any one of Examples 24-37, wherein a first processing core has a different architecture than a second processing core.

Example 39 includes a method comprising: determining, based on information in a thread tracking data structure indicating core execution restrictions for a plurality of threads, whether a thread has an execution restriction for one or more cores of a processor; scheduling the particular thread for execution on a first core of the processor based on the determination; receive an indication from the processor that the thread cannot be executed on the first core; record an execution restriction for the thread in a thread tracking data structure based on the indication; and re-schedule the thread for execution on second processing core of the processor.

Example 40 includes the subject matter of Example 39, wherein the instructions are further to determine whether there is an execution restriction for the thread before re-scheduling the thread for execution on the second processing core.

Example 41 includes the subject matter of Example 39 or 40, wherein the instructions are to record an execution restriction for the first processing core based on the indication.

Example 42 includes the subject matter of Example 41, wherein the instructions are further to record an execution restriction for a plurality of other processing cores based on the indication.

Example 43 includes the subject matter of any one of Examples 39-42, wherein the instructions are further to determine which instruction caused the halted execution and record the execution restriction based on the determination.

Example 44 includes the subject matter of any one of Examples 39-43, wherein the instructions are further to determine a subset of an instruction set architecture (ISA) implemented by the particular thread and record execution restrictions for other threads in the data structure based on the determination.

Example 45 includes an apparatus comprising means to perform a method as in any of Examples 39-44.

Example 46 includes machine-readable storage including machine-readable instructions, when executed, cause a computer to implement a method as in any of Examples 39-44.

Example 47 is computer program comprising instructions which, when the program is executed by a computer, cause the computer to carry out the method as in any of Examples 39-44.

Example 48 is a method for selecting a processing unit for executing an instruction or task in a computing system comprising a plurality of processing units, each processing unit having associated therewith an instruction set architecture (ISA) subset and power efficiency characteristics, the method comprising: presenting a superset ISA to software, the superset ISA including two or more ISA subsets corresponding to a plurality of processing units of the processor; receiving an instruction or task for execution; determining, for the instruction or task, a compatible ISA subset from the two or more ISA subsets based on the instruction or task requirements; identifying one or more processing units from the plurality of processing units that support the compatible ISA subset; selecting a processing unit from the one or more identified processing units to execute the instruction or task; and scheduling the instruction or task for execution on the selected processing unit.

Example 49 includes the subject matter of Example 48, wherein the processing unit is selected based on power efficiency characteristics of each of the one or more identified processing units.

Example 50 includes the subject matter of Example 49, wherein the processing unit is selected based on the processing unit's capability to execute the instruction or task in a more power efficient manner than the other identified processing units.

Example 51 includes at least one non-transitory machine-readable storage medium having instructions stored thereon, wherein the instructions, when executed on a processor, cause the processor to implement the method of any one of Examples 48-50.

Example 52 includes at least one non-transitory machine-readable storage medium having instructions stored thereon, wherein the instructions, when executed on a processor, cause the processor to: obtain a superset ISA indication, the superset ISA including two or more ISA subsets corresponding to a plurality of processing units of the processor; accessing an instruction or task for execution on the processor; determine, for the instruction or task, a compatible ISA subset from the two or more ISA subsets based on the instruction or task requirements; identify one or more processing units from the plurality of processing units that support the compatible ISA subset; select a processing unit from the one or more identified processing units to execute the instruction or task; and cause the instruction or task to be scheduled for execution on the selected processing unit.

Example 53 includes the subject matter of Example 52, wherein the instructions are further to select the processing unit based on power efficiency characteristics of each of the one or more identified processing units.

Example 54 includes the subject matter of Example 53, wherein the instructions are further to select the processing unit based on the processing unit's capability to execute the instruction or task in a more power efficient manner than the other identified processing units.

What is claimed is:

1. An apparatus comprising:
a plurality of processing cores, each processing core to execute at least one of a subset of an instruction set architecture (ISA); and
hardware circuitry to:
determine, during runtime, whether a thread comprising instructions of a particular ISA subset can execute on a particular processing core; and
based on the determination, indicate to software a capability of the thread to be executed on the particular processing core in subsequent executions.

2. The apparatus of claim 1, wherein the circuitry is further to:
detect that the particular processing core cannot execute the instructions of the particular ISA subset; and
based on the detection, halt execution of the thread on the particular processing core.

3. The apparatus of claim 2, wherein the circuitry is to trap execution of the thread or issue an interrupt based on the detection.

4. The apparatus of claim 1, wherein the circuitry is to determine that the thread cannot be executed on the particular processing core based on an attempted execution of the thread on the particular processing core.

5. The apparatus of claim 1, wherein the circuitry is further to indicate a capability of the thread to be executed on other processing cores.

6. The apparatus of claim 1, wherein the ISA is a complex instruction set computer (CISC)-based ISA.

7. The apparatus of claim 1, wherein the ISA is a reduced instruction set computer (RISC)-based ISA.

8. The apparatus of claim 1, wherein a first processing core is to execute a base set of instructions of the ISA and a second processing core is to execute an extension set of instructions of the ISA.

9. The apparatus of claim 8, wherein the extension set of instructions of the ISA includes the base set of instructions of the ISA.

10. The apparatus of claim 1, wherein a first processing core has a different architecture than a second processing core.

11. At least one non-transitory machine-readable storage medium having instructions stored thereon, wherein the instructions, when executed on processing circuitry, cause the processing circuitry to:
determine, based on information in a data structure indicating core execution restrictions for a plurality of threads, whether a thread has an execution restriction for one or more cores of the processing circuitry;
schedule the particular thread for execution on a first core of the processing circuitry based on the determination;
receive an indication from the processing circuitry that the thread cannot be executed on the first core;
record an execution restriction for the thread in a thread tracking data structure based on the indication; and
re-schedule the thread for execution on second processing core of the processing circuitry.

12. The storage medium of claim 11, wherein the instructions are further to determine whether there is an execution restriction for the thread before re-scheduling the thread for execution on the second processing core.

13. The storage medium of claim 11, wherein the instructions are to record an execution restriction for the first processing core based on the indication.

14. The storage medium of claim 13, wherein the instructions are further to record an execution restriction for a plurality of other processing cores based on the indication.

15. The storage medium of claim 11, wherein the instructions are further to determine which instruction caused the halted execution and record the execution restriction based on the determination.

16. The storage medium of claim 11, wherein the instructions are further to determine a subset of an instruction set architecture (ISA) implemented by the particular thread and record execution restrictions for other threads in the data structure based on the determination.

17. A system comprising:
first processor to execute a first instruction set architecture (ISA);
second processor to execute a second ISA; and
hardware circuitry to:
determine, during runtime, whether a thread comprising instructions of a particular ISA can execute on a particular processor; and
based on a determination, indicate a capability of the thread to be executed on the particular processor in subsequent executions.

18. The system of claim 17, wherein the first ISA is a complex instruction set computer (CISC)-based ISA and the second ISA is a reduced instruction set computer (RISC)-based ISA.

19. The system of claim 18, wherein the first processor comprises a plurality of processing cores to execute at least one of a subset of the first ISA, and the circuitry is further to:
determine, during runtime, whether a thread comprising instructions of a particular ISA subset can execute on a particular processing core of the first processor; and
based on the determination, indicate a capability of the thread to be executed on the particular processing core in subsequent executions.

20. At least one non-transitory machine-readable storage medium having instructions stored thereon, wherein the instructions, when executed on a processor, cause the processor to:
obtain a superset ISA indication, the superset ISA including two or more ISA subsets corresponding to a plurality of processing units of the processor;
accessing an instruction or task for execution on the processor;
determine, for the instruction or task, a compatible ISA subset from the two or more ISA subsets based on the instruction or task requirements;
identify one or more processing units from the plurality of processing units that support the compatible ISA subset;
select a processing unit from the one or more identified processing units to execute the instruction or task; and
cause the instruction or task to be scheduled for execution on the selected processing unit.

21. The computer-readable medium of claim 20, wherein the instructions are further to select the processing unit based on power efficiency characteristics of each of the one or more identified processing units.

22. The computer-readable medium of claim 21, wherein the instructions are further to select the processing unit based on the processing unit's capability to execute the instruction or task in a more power efficient manner than the other identified processing units.
